(19) United States
(12) Patent Application Publication
(10) Pub. No.: US 2013/0130358 A1
(43) Pub. Date: May 23, 2013

(54) Machine Dishwashing Compositions and Methods

(71) Applicant: Maruo Davanzo, Ludwigshafen (DE)

(72) Inventor: Maruo Davanzo, Ludwigshafen (DE)

(21) Appl. No.: 13/806,282

(22) PCT Filed: Jun. 23, 2011
(86) PCT No.: PCT/GB11/51183

§ 371 Date: Feb. 5, 2013

(30) Foreign Application Priority Data
Jun. 23, 2010 (GB) 1010580.7

(51) Int. Cl. C11D 3/386

(52) U.S. Cl. CPC C11D 3/38645; C11D 3/38636
USPC 435/264; 510/226; 510/109

(57) ABSTRACT

A machine dishwashing main-wash detergent composition or a dishwashing machine cleaning composition comprising at least one cellulase enzyme, and at least one pectinase enzyme is provided. The compositions optionally also comprise at least one lipase, surfactant (especially non-ionic surfactant) and a pH buffering system.

### TECHNICAL FIELD

This invention relates to compositions to be used in machine dishwashing applications to remove fibrous residues. The residues may in particular be found on the dishwashing machine filters and may be cellulosic in nature. In particular the present invention provides machine dishwashing main-wash detergent compositions and machine cleaning compositions which are effective in removing such residues. Also provided are methods using such compositions.

### BACKGROUND AND PRIOR ART

Automatic dishwashing (ADW) machines commonly have a filter built in to capture soils and to prevent them being redistributed around the interior of the dishwashing machine during the washing and/or rinsing cycles.

Typically these filters capture soils having a size of about, or greater than about, 1 mm. Users should remove and clean the filter frequently in order to prevent the build up of soils on the filter which can lead to malodours and less efficient performance of the filter and ultimately the dishwashing machine. However many dishwashing machine users do not do this and so the captured soil particles remain on the filter. Some will be washed away over time, but others will remain on the filter and decay, and can cause bad odours. In addition to the formation of bad odours, soil particles may clog the filter. This may cause problems with the circulation of the wash and rinse waters leading to poor cleaning results.

Dishwashing machine users typically associate a dirty filter with the dishwashing being dirty and then belief in the ability of the machine to adequately clean their kitchenware is reduced. It is evident to the dishwashing machine users that the filter is dirty as it is typically readily visible.

However, if the filter of the dishwashing machine is not cleaned frequently, the soils present may become harder to remove, further increasing the consumer's reluctance to do so. They may also become more malodorous over time and eventually the performance of the dishwashing machine may be impaired.

The types of soils which are typically found in the filter are fibrous/cellulosic type residues. These can also be found in other parts of the dishwasher such as the inner part of the spray arm (which cannot be cleaned manually) and also on the items to be cleaned in the dishwasher. However, such residues on the filter have been found to be especially problematic. These residues may come from for example, fruit, vegetable and cereal food products or from the paper labels of jars washed in the dishwashing machine. Whilst such residues can be rinsed out of the dishwashing machine once they have a sufficiently small size to pass through the dish-washing machine filter, they cannot be easily dissolved or otherwise removed without manual intervention.

Most conventional dishwasher machine cleaners are based on organic acids and surfactants to treat limescale deposits and grease build-up. However such commercial compositions are not very effective of help in cleaning vegetable or organic soils from the interior of the dishwashing machine (e.g. from the filters). This vegetable organic soil can be digested by specific enzymes. The normal dishwashing enzymes are unstable or ineffective at such low pH to allow also a good limescale removal performance.

Machine cleaning tablets, e.g. for use in automatic dishwashers, are known from e.g. US 2003/0032568 which discloses compositions comprising lime-scale remover acid, non-ionic surfactants and certain types of detergency enzyme.

Filter cleaning compositions for automatic dishwashing machines are also known from WO 2007/06111. The compositions disclosed therein comprise at least one non-starch carbohydrase, such as a cellulase.

The use of enzymes to clean filters during the production of beer is known from WO98/39402, WO96/23579 and WO98/51776. Cleaning compositions which may be used in automatic dishwashers are also known e.g. from WO98/39402.

If the dishwashing machine is cleaned with only an acid to remove lime-scale deposits (which are typically found therein) and surfactants the fibrous/cellulosic relatively insoluble soils are not removed. However, many enzymes typically used in dishwashing applications are unstable and/or ineffective at the low pHs which are required to allow for good lime-scale removal.

There is therefore a need in the art to provide a composition which provides effective removal of fibrous/cellulosic fibres from the interior of the dishwashing machine (e.g. from the filter) and also from any items contained therein, and especially to provide the effectives within the time taken for a single dishwashing cycle so that the compositions can be used to provide their beneficial effects ‘in-wash’.

Furthermore there is also a need to provide such a composition which further also provides good lime-scale removal properties.

Furthermore there is also a need to provide such a composition which further also provides good grease removal properties.

Also many of the prior art compositions are only used during a washing or rinsing cycle of the dishwashing machine which can be inconvenient for the consumer. Therefore there is also the need in the art for compositions which can reduce fibrous/cellulosic fibres, preferably whilst also providing good lime-scale removal properties which can be used during a loaded or unloaded dishwashing cycle but which can also be used when the dishwashing machine is not undergoing a washing and/or rinse cycle as a leave-on treatment between dishwashing machine cycles if desired.

It is an object of the present invention to address at least one of the above-referenced problems.

In particular the present invention seeks to provide a composition which is effective upon fibrous/cellulosic soils in a dishwashing applications, especially in the cleaning of the interior of the dishwashing machine (for example the filter). It is a further aim to provide such a composition which also provides good lime-scale removal properties. It is still a further aim to provide such compositions which can be used when the dishwashing machine is undergoing a loaded or unloaded washing or rinsing cycle. It is yet a further aim to provide such compositions which can be used when the dishwashing machine is not being used, that is, as a leave-on treatment between dishwashing machine cycles.

### STATEMENT OF INVENTION

Surprisingly it has been found that the combination of at least one cellulase enzyme with at least one pectinase enzyme is very effective in reducing the aforementioned types of soils in automatic dishwashing applications.

Thus according to a first aspect of the invention, there is provided a machine dishwashing main-wash detergent composition or a dishwashing machine cleaner composition comprising;

(i) at least one cellulase enzyme, and
(ii) at least one pectinase enzyme.

It is preferred that the at least one cellulose enzyme is present in an amount of from 0.005 wt % to 2.5 wt % of active enzyme based on the total weight of the composition. The at least one pectinase enzyme is preferably present in an amount of from 0.005 wt % to 2.5 wt % of active enzyme based on the total weight of the composition. The amount of the cellulase enzyme and the pectinase enzyme may be the same or different.

The compositions preferably comprise an active amount of lipase and/or protease, especially lipase, in an amount of from 0.005 wt % to 2.5 wt % of active enzyme based on the total weight of the composition.

It is preferred according to the present invention that the composition further comprises at least one enzyme selected from lipases and proteases, especially lipase.

It has further been found that the use of a lipase and/or protease, especially lipase, in addition to the required combination of enzymes further improves the soil removal, especially within a dishwashing cycle.

It is also preferred that the compositions of the present invention further comprises from 0.1 to 10 wt % alkoxylated non-ionic surfactant based on the total weight of the composition. The inclusion of surfactants, especially alkoxylated non-ionic surfactant, has been found to beneficial for removal of grease in addition to the removal of the fibrous/cellulosic residues.

Preferably wherein the composition is a machine cleaner composition it has an acidic pH, most preferably of between 3 and 6. When the composition is a machine dishwashing main-wash detergent composition it is preferred that it has a pH in the range of from 7 to 11, especially 9 to 11. In both cases pH is measured at 20° C. as a 1 wt % solution in deionised water.

It is also preferred that when the composition is a machine cleaner composition it further comprises a citrate based buffering system to maintain the pH of the composition within the desired limits.

When the composition has an acidic pH this provides the additional benefit of providing lime-scale removal properties in addition to the soil removal properties thus improving the overall performance of the compositions. It is especially preferred according to the present invention that the compositions additionally comprise at least one lipase and have an acidic pH (especially through the use of a citrate based buffering system) to provide good soil removal and lime-scale removal properties (which are typically provided during the time taken for a normal dishwashing cycle).

It is especially preferred according the present invention that the compositions of the first aspect comprise at least one cellulase enzyme, at least one pectinase enzyme, at least one lipase enzyme, non-ionic surfactant (especially alkoxylated non-ionic surfactant) and a buffering system (especially a citrate based buffering system).

According to the second aspect of the present invention, there is provided a method of cleaning the interior of an automatic dishwasher comprising contacting at least a part of the interior of the dishwasher with a composition according to the first aspect of the invention including with a diluted form thereof) whilst the automatic dishwasher is undergoing a washing and/or rinsing cycle.

The dishwasher may be loaded with items to be cleaned or it may be unloaded (empty).

According to one embodiment of the second aspect it is preferred that the composition is a machine dishwashing main-wash detergent composition when the dishwasher is loaded with kitchenware to be cleaned. According to another embodiment of the second aspect it is preferred that the composition is a machine cleaning composition when the dishwasher is not so loaded.

It is especially preferred that at least the dishwashing filter is contacted with the composition according to the second aspect of the invention. This aspect of the invention has the advantage that the interior of the dishwashing machine can be cleaned in a single cycle. It can also provide the benefit that the dishwasher can be loaded during the cycles to remove the fibrous residues therefore reducing or obviating the need for additional cycles to be carried out in an unloaded machine to remove said soils.

It is of course possible for the dishwasher to be run with either loaded or unloaded cycles using either the machine dishwashing main-wash detergent composition or the machine cleaning composition. However, typically the machine dishwashing main-wash detergent composition would be used in loaded cycles whilst the machine cleaning composition would be used in unloaded cycles.

According to a third aspect of the invention, there is provided a method of cleaning the interior of an automatic dishwasher, the method comprising contacting at least a part of the interior of the dishwasher with a composition of the first aspect of the invention (including with a diluted form thereof) whilst the automatic dishwasher is not undergoing a washing or rinsing cycle.

Preferably the composition is in contact with at least a part of the interior of the dishwasher for a period of at least 10 minutes.

According to the fourth aspect of the present invention, there is provided a product comprising a container and dispensing means, wherein the container comprises a composition according to the first aspect of the present invention.

It is preferred that the composition is at least partially water soluble or water dispersible.

According to the fifth aspect of the present invention, there is provided the use of a machine dishwashing main-wash detergent composition or a dishwashing machine cleaning composition comprising;

(i) at least one cellulase enzyme, and
(ii) at least one pectinase enzyme, to degrade fibrous/cellulosic residues in an automatic dishwasher.

Without wishing to be bound by theory, it is believed that the combination of at least one cellulase enzyme and at least one pectinase enzyme is very effective at removing insoluble organic residues which are typically encountered in dishwashing operations, especially insoluble fruit and vegetable residues and cereals. It has also further been found that the addition of lipase to the combination of cellulase and pectinase provides even better results for the removal of such residues. Without the cellulase or, alternatively, without the pectinase, the filter cleaning action is diminished. These two enzymes have been found to work together to degrade the vegetable tissues around the fibers in the soils (mostly pectin) and then attack the fibers (cellulose). Additionally the acidic nature of the compositions, the lipase and surfactants (when used) help to break the external surface of the soil and enter it with the cellulase and pectinase.

The purpose of the compositions of the invention is to degrade tough fibrous/cellulosic soils which may otherwise be difficult to remove from the items to be cleaned by the dishwashing machine and/or from the interior of the dishwashing machine such as from the filter. Soils which can be broken down by the composition of the invention include cereals, fruits and vegetables. Some specific examples include lettuce, asparagus, full-grain bread, orange and lemon peels, apple pieces and spinach.

Once degraded the soils may pass easily through the filter and be washed away out of the dishwashing machine. In the case of a manual application of the machine cleaner when the dishwashing machine is not operated this will typically occur during the next regular dishwashing operation of the dishwasher unless the degraded soil residues are manually rinsed away or removed. However when the composition is a machine cleaning composition which is used during a dummy cycle or the composition is a machine dishwashing main-wash detergent composition this will occur during the outflow of water during the dummy cycle/washing cycle of the dishwasher operation.

In this specification a reference to the percentage amount of the defined component is to its percentage by weight based on the total weight of the relevant composition, unless otherwise stated.

The term ‘machine dishwashing main-wash detergent composition’ as used herein represents detergent compositions intended to be used in the main cleaning cycle of an automatic dishwashing machine when the machine is loaded with kitchenware to be cleaned.

References in this specification to a component, for example a non-starch carbohydrase, embrace the possibility that there may be only one such component present, or more than one. When a percentage value is stated for a component in a general definition given herein (including in any claim) that value denotes the total amount present, when more than one such component is present unless otherwise stated. For example when we state that there may suitably be present at least Xwt % of at least one cellulase enzyme, this figure denotes the total amount of all the types of cellulase enzyme present unless otherwise stated.

### DETAILED DESCRIPTION

### (i) The Compositions

The compositions of the invention may be either a machine dishwashing main wash detergent composition or a dishwashing machine cleaner composition (hereinafter referred to as machine cleaner composition).

When the composition is a machine dishwashing main wash detergent composition it may added to the dishwashing machine loaded/to be loaded with items to be cleaned and it is provided in a manner such that it will be able to active in at least the main wash cycle of the dishwashing machine. This is one embodiment of the second aspect of the invention. Typically it is the machine dishwashing main wash detergent composition which is used when the dishwasher is loaded and operated on a wash cycle. Typically the composition will be added to the dispensing draw or cup of the dishwashing machine and released automatically at the required part of the dishwashing cycle. Alternatively the composition may be added by the consumer directly into the interior of the dishwashing machine prior to starting the dishwashing cycle. It is however possible to use the dishwashing machine main wash detergent composition by applying it to the interior in a manner such that it is in contact therewith between cycles of the dishwasher.

When the composition of the invention is used between regular dishwashing operations; that is, between regular operations of the dishwasher (loaded cycles used to wash kitchenware, for example dishes, cutlery and the like) the compositions can be added in any suitable manner. This between loaded-cycles treatment can take the form of either an unloaded machine cycle (second aspect of the invention) or prolonged contact of the composition and the interior of the dishwasher when a cycle of the dishwasher is not operated (third aspect of the invention).

For the use of the compositions of the invention in a non-loaded cycle the application of the composition will usually be carried out by placing the composition either directly into the interior of the machine or alternatively into the dispensing draw of the machine.

Thus in this embodiment of the invention, the compositions of the present invention may be used when the dishwasher is empty of kitchenware but the dishwashing cycle is operated (second aspect of the invention). In this embodiment the machine cleaner composition is delivered to the dishwasher and the machine is operated, but in a dummy cycle, i.e. without kitchenware being present. The whole machine may thereby be cleaned, including the filter. Either the dishwashing main-wash detergent compositions or the machine cleaner compositions may be used for this purpose.

For the use of the compositions of the invention when the dishwasher is not being operated the application of the composition will usually occur manually by application of the composition to areas in the interior of the dishwasher which require removal of fibrous soils (e.g. the filter).

Thus in this embodiment of the invention, the compositions of the present invention may be used when the dishwasher is not being operated. In this embodiment the compositions of the invention will preferably be left in contact with the interior of the dishwasher, or a part thereof, for a period of time whilst the dishwasher is not in use. Preferably the contact period is at least 10 minutes, more preferably at least 30 minutes. The composition is washed from the dishwasher during the next regular operation of the dishwasher (hereinafter a “filter-specific cleaning embodiment”) or is manually removed e.g. by rinsing. For example, the composition may be applied to the filter and the dishwasher left, until it is next needed. Preferably the dishwasher is empty of kitchenware. Again either the dishwashing main-wash detergent compositions or the machine cleaner compositions may be used for this purpose.

The compositions of the present invention are particularly suitable for cleaning the filters of the dishwashing machine which retain fibrous/cellulosic soil particles in automatic dishwashers. However, e.g. when used as a machine cleaning composition it may also be specifically applied to other areas of the dishwasher machine where stubborn soils have deposited.

The machine dishwashing main-wash detergent composition and the machine cleaner composition of the invention may be of any suitable physical form including powder, tablet, shaped body, liquid, foam, aerosol and gels, Such compositions may be enclosed within a water soluble wrapper or container which dissolves, at least in part, during use to release its contents. Such suitable containers include those formed from water soluble polymers such as poly vinyl alcohol. If the compositions are contained within a water insoluble wrapper or container they can be dispensed therefrom into the interior of the dishwasher. In such cases the compositions can be dispensed from the container into the dishwashing machine prior to the start of any dishwashing cycle or the water insoluble container can be placed in the interior of the dishwasher and the contents released therefrom during the dishwashing machine cycle e.g. by the dissolution or dispersion of a part of the container cap. The composition, e.g. machine cleaner composition, may be added to the dishwashing machine as a single dose which is distributed around the interior of the dishwashing machine as it is in use, or alternatively, it may be applied to specific areas of the dishwashing machine (for example the filter) by any available means, for example a trigger spray, squeeze bottle or an aerosol.

If the composition is in liquid, gel or foam form then it is an aqueous composition although any suitable solvent may be used. In such cases the composition preferably comprises at least 50 wt % water, preferably at least 70 wt %, more preferably at least 90 wt % and most preferably at least 95 wt % water based on the total weight of the composition.

When the composition of the invention is a machine dishwashing main wash detergent composition it is preferred that the pH of the composition is at least 7, such as at least 9, preferably in the range of from 7 to 11, such as in the range of from 9 to 11, most preferably 9.2 to 10.5 (measured as a 1 wt % solution in de-ionised water at 20° C.).

When the composition of the invention is a machine cleaner composition it is preferred that the pH of the composition is less than 9 (measured as a 1 wt % solution in de-ionised water at 20° C.). More preferably the machine cleaner composition is acidic. Preferably the pH is 6 or below, more preferably it is 5 or below. In preferred embodiments the machine cleaner composition has a pH of between 3 and 6, more preferably of between pH 3 and 5. In another embodiment the pH may suitably be from 7 to 9.

All compositions of the invention may be produced by any suitable method of preparation as well known in the art.

### (ii) Cellulase and Pectinase Enzymes

All compositions of the present invention (both the main wash detergent and the machine cleaner) comprise;

(i) at least one cellulase enzyme, and
(ii) at least one pectinase enzyme.

Preferably all compositions of the invention comprise at least 0.005 wt % (based on the amount of active enzyme) of the at least one cellulase enzyme, more preferably at least 0.075 wt %, most preferably at least 0.01 wt % and up to 10 wt % (based on the amount of active enzyme) of the at least one cellulase enzyme, more preferably up to 5 wt %, most preferably up to 2.5 wt %, such as up to 1 wt % including all ranges subsumed therein. It is most preferred that the compositions comprise an active amount of the at least one cellulase enzyme in the range of from 0.005 wt % to 2.5 wt %.

Preferably all compositions of the invention comprise at least 0.005 wt % (based on the amount of active enzyme) of the at least one pectinase enzyme, more preferably at least 0.075 wt %, most preferably at least 0.01 wt % and up to 10 wt % (based on the amount of active enzyme) of the at least one pectinase enzyme, more preferably up to 5 wt %, most preferably up to 2.5 wt %, such as up to 1 wt % including all ranges subsumed therein. It is most preferred that the compositions comprise an active amount of the at least one pectinase enzyme in the range of from 0.005 wt % to 2.5 wt %.

It is especially preferred for all compositions of the present invention that they comprise both the at least one cellulase and the at least one pectinase in the aforementioned amounts and most preferably that they comprise both enzymes in an amount of 0.005 wt % to 2.5 wt % active enzyme based on the total weight of the composition.

In terms of the active amount of cellulase and pectinase enzyme to be delivered per unit dose of composition it is preferred that the amount is preferably at least 10 mg, more preferably at least 50 mg; and preferably up to 75 mg or 100 mg for each enzyme.

It is preferred that the weight ratio of the active amount of the cellulase to the active amount of the pectinase is in the ratio of from 10:1 to 1:10, more preferably 5:1 to 1:5, such as 2:1 to 1:2. Ratios of around 1:1 have been found to be very effective.

Any cellulase which is suitable for use in automatic dishwashing applications may be used according to the present invention. Suitable commercially available cellulases include Celluzyme 0.7T, Accelerase (including Accelerase XC) and Celluclast NS17034. Any pectinase which is suitable for use in automatic dishwashing applications may be used according to the present invention. Suitable commercially available pectinases include Pektozyme Powerclear L and Pectin-lyase NS 17041/1741 and Multifect Pectinase FE which of course can be used in the above stated amounts.

(iii) Additional Optional Enzymes

It is especially preferred that the compositions of the invention (both the machine dishwashing main-wash detergent compositions and the machine cleaning compositions) further comprise at least one enzyme selected from lipases and proteases, especially at least one lipase.

Preferably all compositions of the invention comprise at least 0.005 wt % (based on the amount of active enzyme) of the at least one lipase and/or protease enzyme in addition to the required combination of the at least one cellulase enzyme and at least one pectinase enzyme. More preferably the compositions comprise at least 0.075 wt %, most preferably at least 0.01 wt % and up to 10 wt % (based on the amount of active enzyme) of the at least one at least one lipase and/or protease enzyme, more preferably up to 5 wt %, most preferably up to 2.5 wt %, such as up to 1 wt % including all ranges subsumed therein. It is most preferred that the compositions comprise an active amount of the at least one lipase and/or protease enzyme, especially lipase, in the range of from 0.005 wt % to 2.5 wt % for each of these optional enzymes used in the compositions of the invention. Suitable commercially available lipases include Lipex 100L and Lipolase 100L which of course can be used in the aforementioned amounts.

It is believed that the addition of the lipase helps to remove fatty matter in the soils which in turns aids the effectiveness of the cellulase and the pectinase enzymes.

It is preferred that the weight ratio of the active amount of the lipase to the total active amount of the cellulase and pectinase is in the ratio of from 10:1 to 1:10, more preferably 5:1 to 1:5, such as 2:1 to 1:2. Ratios of around 1:1 have been found to be very effective.

Other enzymes which may optionally be used in the compositions of the invention include xylanases and amylases. These enzymes may be included in the same amounts as the lipase and/or protease enzymes.

### (iv) Optional Surfactants

The machine dishwashing main-wash detergent compositions and the machine cleaning compositions of the present invention preferably comprise non-ionic surfactants. Preferably the compositions of the invention comprise less than 10 wt % surfactant, preferably less than 7.5 wt %, more preferably less than 5 wt %, such as less than 2.5 wt % based on the total weight of the compositions. It is preferred that the compositions comprise at least 0.1 wt % surfactant, more preferably 1 t least 0.5 wt %, such as at least 0.75 wt % surfactant. Preferred compositions comprise 0.1 to 5 wt % surfactant, such as 0.5 to 2.5 wt % surfactant.

When the composition of the invention is a machine dishwashing main-wash detergent composition it will typically comprise up to 5 wt % of surfactant and machine cleaning compositions will typically comprise up to 2.5 wt % of surfactant based on the total weight of the composition.

Suitable surfactants include non-ionic, cationic or amphoteric surfactants, or mixtures thereof and these are preferably included in the aforementioned amounts. Low foaming non-ionic surfactants are especially preferred. Many such surfactants are described in Kirk Othmer's Encyclopaedia of Chemical Technology, 3rd Ed., Vol. 22, pp. 360-379, “Surfactants and Detersive Systems”, incorporated by reference herein. In general, when a bleach is incorporated into the formulation (for example for a main-wash detergent composition) bleach-stable surfactants are preferred. Non-ionic surfactants are especially preferred according to the invention.

An especially preferred class of nonionic surfactants according to the present invention are alkoxylated non-ionic surfactants, including ethoxylated non-ionic surfactants and mixed alkoxylate non-ionic surfactants such as those having a mixture of EO/PO or BU/PO units etc. Preferred types of alkoxylated non-ionic surfactants are those prepared by the reaction of a monohydroxy alkanol or alkylphenol with 6 to 20 carbon atoms with preferably at least 10 moles particularly preferred at least 12 moles, and still more preferred at least 16 moles, such as at least 20 moles of alkylene oxide, such as ethylene oxide per mole of alcohol or alkylphenol.

Particularly preferred non-ionic surfactants are the non-ionics from a linear chain fatty alcohol with 16-20 carbon atoms and at least 12 moles particularly preferred at least 16 and still more preferred at least 20 moles of ethylene oxide per mole of alcohol.

According to one preferred embodiment of the invention, the non-ionic surfactants additionally comprise propylene oxide units in the molecule. Preferably these PO units constitute up to 25% by weight, preferably up to 20% by weight and still more preferably up to 15% by weight of the overall molecular weight of the non-ionic surfactant. Particularly preferred surfactants for use in the compositions of the invention are ethoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of nonionic surfactant can be described by the formula:

R¹O[CH₂CH(CH₃)O]ₓ[CH₂CH₂O]_{y}[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]ₓ[CH₂]ₖCH(OH)[CH₂]ⱼOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³H, methyl or ethyl are particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R³═H) or propylene oxide (R³=methyl) units which can be used in every single order for instance (PO) (EO) (EO), (EO) (PO) (EO), (EO) (EO) (PO), (EO) (EO) (EO), (PO) (EO) (PO), (PO) (PO) (EO) and (PO) (PO) (PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]_{X}CH₂CH(OH)CH₂OR²

The use of mixtures of different nonionic surfactants is suitable in the context of the present invention for instances mixtures of alkoxylated alcohols and hydroxy group containing alkoxylated alcohols.

It is especially preferred that the compositions of the invention comprise from 0.1 to 10 wt % alkoxylated non-ionic surfactant, more preferably 0.5 to 5 wt % based on the total weight of the composition. Preferably the alkoxylated non-ionic surfactant comprises ethoxylate groups. The amount of surfactant used in the composition may vary as discussed above according to whether the composition is a main wash detergent composition or a machine cleaner composition.

The surfactants aid generally with the removal of grease from the interior of the dishwasher.

### (v) Optional pH Buffering System

The compositions of the invention may comprise a pH buffering system to maintain the desired pH range during storage and use.

When the composition of the invention is a machine cleaning composition it is preferred that a buffering system is included which keeps the pH at the preferred range for this type of composition. It is especially preferred for these types of compositions that the buffering system is citrate based (for example citric acid with NaOH, such as anhydrous 55 wt % with NaOH to provide a pH in the ranges recited above). It is within the skill of the person skilled in the art to easily determine the amount of buffering system to be added to achieve the desired pH. Depending upon the desired pH of the machine dishwashing main-wash detergent composition such a buffering system may also be used for this type of composition. However, it is more usual that a machine dishwashing main-wash detergent composition will have a pH of 7 or above or 9 or above and would be buffered by an alkaline buffering system. Alkaline buffering systems for dishwashing main wash detergent compositions are well known in the art. It is well within the ability of the skilled person to employ a suitable alkaline buffering system.

It is believed that the buffering system, especially an acidic buffing system, and preferably a citrate based buffering system, helps to stabilise the enzymes whilst at the same time acts as a lime-scale remover which further improves the overall cleaning of the dishwashing machine and/or of the items being cleaned therein.

### (vi) Other Optional Ingredients

The compositions of the invention may optionally comprise one or more bleaching compounds, especially when the composition is a machine dishwashing main-wash detergent composition. Any conventional bleaching compound can be used in any conventional amount.

When a bleaching compound is present, it is preferably present in an amount of at least 1 wt %, more preferably at least 2 wt %, more preferably at least 4 wt %. Preferably it is present in the relevant composition in an amount of up to 30 wt %, more preferably up to 20 wt %, and most preferably up to 15 wt %. Amounts of 1% to 30 wt % of bleach component are especially preferred.

Most preferably the bleach is selected from inorganic peroxy-compounds and organic peracids and the salts derived therefrom.

Examples of inorganic perhydrates include persulfates such as peroxymonopersulfate (KMPS), perborates or percarbonates. The inorganic perhydrates are normally alkali metal salts, such as lithium, sodium or potassium salts, in particular sodium salts. The inorganic perhydrates may be present in the detergent as crystalline solids without further protection. For certain perhydrates, it is however advantageous to use them as granular compositions provided with a coating which gives the granular products a longer shelf life. The preferred percarbonate is sodium percarbonate of the formula 2Na₂CO₃.3H₂O₂. A percarbonate, when present, is preferably used in a coated form to increase its stability.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

When a composition of the invention comprises a bleaching compound it may also comprise one or more bleach activators or bleach catalysts depending upon the nature of the bleaching compound. Any suitable bleach activator may be included for example TAED. Any suitable bleach catalyst may be used for example manganese acetate or dinuclear manganese complexes such as those described in EP-A-1,741,774. Conventional amounts may be used e.g. in amounts of from 1 to 30 t %, more preferred of from 5 to 25 wt % and most preferred of from 10 to 20 wt % based on the weight of the part of the composition comprising the bleach.

An especially preferred optional ingredient is a builder compound, especially when the composition of the invention is a machine dishwashing main-wash detergent composition. The compositions may comprise conventional amounts of detergent builders which may be either phosphorous based or non-phosphorous based, or a combination of both types. Suitable builders are well known in the art.

If phosphorous containing builders are to be used then it is preferred that mono-phosphates, di-phosphates, tri-polyphosphates, polyphosphonates or oligomeric-poylphosphates are used. The alkali metal salts of these agents are preferred, in particular the sodium salts. An especially preferred phosphorous containing builder is sodium tripolyphosphate (STPP). Conventional amounts of the phosphorous-containing builders may be used in the solid detergent compositions, typically in the range of from 15 wt % to 80 wt %, such as 20 wt % to 75 wt %, more preferably 25 wt % to 60 wt % based on the total weight of the composition.

The non-phosphorous containing builder may be organic molecules with carboxylic group(s), amino acid based compounds, a succinate based compound or a mixture thereof. The term ‘succinate based compound’ and ‘succinic acid based compound’ are used interchangeably herein and these compounds are further described below.

Builder compounds which are organic molecules selected from water-soluble monomeric polycarboxylic acids and/or their acid forms may be used according to the invention. Suitable polycarboxylic acids include acyclic, alicyclic, heterocyclic and aromatic carboxylic acids. Suitable examples of such compounds include citric acid, fumaric acid, tartaric acid, maleic acid, lactic acid, (ethylenedioxy)diacetic acid, tartronic acid, lactic acid, glycolic acid, malonic acid, diglycolic acid and fumaric acid and salts and derivatives thereof, especially the water soluble salts thereof. Preferred salts of the abovementioned compounds are the ammonium and/or alkali or alkaline earth metal salts, e.g. the ammonium, lithium, sodium, potassium or calcium salts, and particularly preferred salts are the sodium salts. These acids may be used in their monomeric or oligomeric form. An especially preferred builder is sodium citrate.

Preferred examples of amino acid based compounds according to the invention are MGDA (methyl-glycine-diacetic acid, and salts and derivatives thereof) and GLDA (glutamic-N,N-diacetic acid) and salts and derivatives thereof. Other suitable builders are described in U.S. Pat. No. 6,426,229 which is incorporated by reference herein. A preferred MGDA compound is a salt of methyl glycine diacetic acid. Suitable salts include the triammonium salt, the tripotassium salt and, preferably, the trisodium salt. A preferred GLDA compound is a salt of glutamic diacetic acid. Suitable salts include the tetraammonium salt, the tetrapotassium salt and, preferably, the tetrasodium salt. Especially preferred are the sodium salts thereof.

In particular suitable builders include; for example, aspartic acid-N-monoacetic acid (ASMA), aspartic acid-N,N-diacetic acid (ASDA), iminodisuccinic acid (IDA), aspartic acid-N-monopropionic acid (ASMP), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulphanilic acid-N,N-diacetic acid (SLDA), taurine-N,N-diacetic acid (TUDA) and sulphomethyl-N,N-diacetic acid (SMDA) and alkali metal salts or ammonium salts thereof.

Preferred succinate compounds are described in U.S. Pat. No. 5,977,053 and have the formula;

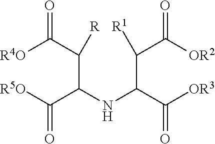

in which R, R¹, independently of one another, denote H or OH, R², R³, R⁴, R⁵, independently of one another, denote a cation, hydrogen, alkali metal ions and ammonium ions, ammonium ions having the general formula R⁶R⁷R⁸R⁹N+ and R⁶, R⁷, R⁸, R⁹, independently of one another, denoting hydrogen, alkyl radicals having 1 to 12 C atoms or hydroxyl-substituted alkyl radicals having 2 to 3 C atoms. Iminodisuccinic acid (IDS) and (hydroxy)iminodisuccinic acid (HIDS) and alkali metal salts or ammonium salts thereof are especially preferred succinate based builder salts. Especially preferred are the sodium salts thereof.

MGDA, GLDA, IDS and HIDS are especially preferred builders according to the present invention and mixtures thereof may also be used. Any suitable form of the amino acid and succinate based compounds in the preceding paragraphs may be used.

Preferably the total amount of builder present in the composition is at least 10 wt %, and most preferably at least 15 wt %, preferably in an amount of up to 80 wt %, preferably up to 65 wt %, more preferably up to 60 wt %. The actual amount used in the compositions will depend upon the nature of the builder used.

When the compositions of the invention are in liquid/gel/foam form the compositions preferably comprise a viscosity modifier, e.g., a thickener which increases the viscosity of the cleaning composition. This is especially preferably when the compositions of the invention are to be used as a manually applied machine cleaner composition. When the viscosity modified is used it is preferably present in an amount of at least 0.1 wt %, preferably at least 0.2 wt % based on the total weight of the composition. Preferably the composition comprises up to 3 wt % of a viscosity modifier, more preferably up to 2 wt %. Suitable viscosity modifiers include polycarboxylate polymers, polyacrylamides, clays, and mixtures thereof.

Both the machine dishwashing main-wash detergent composition and the machine cleaner composition of the present invention may individually comprise one or more of the following optional ingredients in conventional amounts.

An odour-control agent may be included to combat any malodour which may develop in the dishwasher due to decaying soils or bacteria. Suitable odour-control agents include enzymes such as oxidases for example laccases and glucose-oxidases which can generate hydrogen peroxide in situ; or an alternative source of hydrogen peroxide. Where such enzymes are included they are in addition to the cellulases, pectinases and lipases referred to hereinabove. A preferred odour-control agent is a glucose-oxidase. This is preferably present in an amount of at least 0.1 wt %, preferably at least 0.4 wt %. Preferably it is present in an amount up to 5 wt %, preferably up to 2 wt % based on the total weight of the composition.

Preferably the compositions include a fragrance, suitably at least 0.01 wt %, preferably at least 0.05 wt %, thereof; suitably up to 1 wt o, preferably up to 0.3 wt % based on the total weight of the composition.

The compositions may include a preservative. Exemplary preservatives which may form part of the composition include useful water soluble or water dispersible compositions which include terpenes and parabens, including methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof.

The composition may include further anti-microbially effective agents, such as a biocide, e.g., pyrithiones (especially zinc pyrithione which is also known as ZPT), dimethyldimethylol hydantoin (available under the tradename Glydant), methylchloroisothiazolinone/methylisothiazolinone (available under the tradename Kathon CG), sodium sulphite, sodium bisulphite, imidazolidinyl urea (available under the tradename Germall 115), diazolidinyl urea (available under the tradename Germaill II), benzyl alcohol, 2-bromo-2-nitropropane-1,3-diol (available under the tradename Bronopol), formalin (formaldehyde), iodopropenyl butylcarbamate (available under the tradename Polyphase P100), chloroacetamide, methanamine, methyldibromonitrile glutaronitrile (1,2-dibromo-2,4-dicyanobutane or available under the tradename Tektamer), glutaraldehyde, 5-bromo-5-nitro-1,3-dioxane (available under the tradename Bronidox), phenethyl alcohol, o-phenylphenol/sodium o-phenylphenol, sodium hydroxymethylglycinate (available under the tradename Suttocide A), polymethoxy bicyclic oxazolidine (available under the tradename Nuosept C), dimethoxane, thimersal dichlorobenzyl alcohol, captan, chlorphenenesin, dichlorophene, chlorbutanol, glyceryl laurate, halogenated diphenyl ethers like 2,4,4-trichloro-2-hydroxy-diphenyl ether (available under the tradename Triclosan or TCS), 2,2-dihydroxy-5,5-dibromo-diphenyl ether, phenolic anti-microbial compounds like phenol, phenols substituted by C₁₋₈ alkyls group(s) and/or by halogen atom(s) and/or by benzyl group(s), resorcinol and its derivatives, 5-chloro 2,4-dihydroxydiphenyl methane, 4-chloro 2,4-dihydroxydiphenyl methane, 5-bromo 2,4-dihydroxydiphenyl methane, and 4-bromo 2,4-dihydroxydiphenyl methane, bisphenolic compounds like 2,2-methylene bis(4-chlorophenol), 2,2-methylene bis(3,4,6-trichlorophenol), 2,2-methylene bis(4-chloro-6-bromophenol), bis(2-hydroxy-3,5-dichlorophenyl) sulphide, and bis(2-hydroxy-5-chlorobenzyl)sulphide, benzoic esters (parabens) like methylparaben, propylparaben, butylparaben, ethylparaben, isopropylparaben, isobutylparaben, benzylparaben, sodium methylparaben, and sodium propylparaben, halogenated carbanilides (e.g., 3,4,4-trichlorocarbanilides (available under the tradename Triclocarban or TCC), 3-trifluoromethyl-4,4-dichlorocarbanilide or 3,3,4-trichlorocarbanilide.

The compositions of the invention may comprise other optional excipients for example dyes and stabilizers. Suitably dyes may include food grade dyes such as Ultramarin Blue and Patentblau from Clariant.

(vii) Methods of Using the Compositions

According to the second aspect of the present invention, there is provided a method of cleaning the interior of an automatic dishwasher, and in particular the filter, the method comprising contacting at least a part of the interior of the dishwasher, and in particular the filter, with a composition according to the first aspect (including with a diluted form thereof) whilst the automatic dishwasher is undergoing a washing and/or rinsing cycle. According to this aspect of the invention the dishwasher may be loaded or unloaded with items to be cleaned during the washing and/or rinsing cycle.

According to one embodiment of the second aspect of the invention, when the dishwashing machine contains items of kitchenware in its interior during the washing and/or rinsing cycle it is preferred that the composition is a machine dishwashing main-wash detergent composition. However, it is also possible that a machine cleaner composition could be used.

According to another embodiment of the second aspect of the invention, when the dishwashing machine is empty during the washing and/or rinsing cycle it is preferred that the composition is a machine cleaning composition. However it is also possible that a machine dishwashing main-wash detergent composition could be used.

When the composition of the invention is used according o the second aspect of the invention the composition is distributed throughout the interior of the dishwasher by the spray mechanism of the dishwashing machine; but at any given time there will be contact with the filter and other parts of the interior of the machine and of course the water containing the composition must drain through the filter. This leads to especially good cleaning of the filter.

It has been found that the compositions of the invention provide excellent removal of fibrous soils from the interior of the dishwashing machine when used during a machine washing and/or rinsing cycle. It has also been found that the compositions can successfully be used to remove these soils by being applied directly to the areas of the dishwashing machine requiring treatment and by leaving the compositions to act on the soils without a cycle of the dishwasher being operated.

According to the third aspect of the present invention, there is provided a method of cleaning the interior of an automatic dishwasher, and in particular the filter, the method comprising contacting at least a part of the interior of the dishwasher, and in particular the filter, with a composition according to the first aspect (including with a diluted form thereof) whilst the automatic dishwasher is not undergoing a washing or rinsing cycle. Preferably the composition is contacted for a period of at least 10 minutes with at least a part of the interior of the dishwasher. Typically the dishwasher is not loaded with items to be cleaned during this contact time. The dishwasher is not operated (i.e. no dishwashing cycle is run).

In this embodiment the composition may be washed out of the dishwasher when it is next used in a regular dishwashing operation, whether that is 10 minutes, 1 hour, hours or 24 hours later or it could be rinsed off manually as desired. Preferably the composition is delivered to the dishwasher shortly after the end of the previous dishwashing operation, to maximise the residence time. In this embodiment the composition may be applied directly to the filter or it may be applied liberally throughout the dishwasher and allowed to drain into the filter.

Preferably the contact period according to the second aspect of the invention is at least 30 minutes, more preferably at least 60 minutes and most preferably at least 2 hours, more preferably at least 4 hours. Suitably it may be left overnight. Preferably the composition is left in the dishwasher for a period of less than 48 hours, preferably less than 36 hours, more preferably less than 24 hours.

The composition used in the third aspect of the invention may be either a machine dishwashing main wash detergent composition or a machine cleaner composition. Preferably it is a machine cleaner composition. Preferably the composition is contacted with the filter of the dishwasher.

Cleaning for the second to fourth aspects of the invention is assessed as being a reduction in the level of fibrous/cellulosic residues in the interior of the automatic dishwasher/filter and where appropriate (as the dishwashing machine is being run with a load inside it) of the articles inside the dishwashing machine.

The compositions of the invention may be provided as a product comprising a container having a dispensing means, wherein the container comprises a composition according to the first aspect. This forms the fourth aspect of the present invention. The compositions may be either a machine dishwashing main wash detergent composition or a machine cleaner composition.

The dispensing means allows delivery of the composition to a locus, and may suitably comprise a nozzle, spout or tapered opening. In preferred embodiments in which the composition is in the form of a thick viscous liquid, it may be poured directly onto the filter or other part of the interior of the dishwasher. It may, for example, be dispensed from a bottle shaped to aid pouring or a tube or a bottle adapted to be squeezed in order to release the contents. Alternatively the dispensing means may take the form of a water soluble lid, cap or film which dissolves in water during use, to release the composition held inside the container.

According to a preferred embodiment of the invention the container is at least partially and preferably substantially water soluble and dissolves or disperses in water in use, preferably during a dishwashing machine cycle. Typically such a container has a water soluble film lid and may be of any suitable size and shape. For example it may be placed in the dispensing draw of a dishwasher or be placed in the plate rack of the machine.

According to the fifth aspect of the present invention, there is provided the use of a machine dishwashing main-wash detergent composition or a dishwashing machine cleaning composition comprising;

(i) at least one cellulase enzyme, and
(ii) at least one pectinase enzyme, to degrade fibrous/cellulosic residues in an automatic dishwasher.

The invention will now be further described by way of the following non-limiting examples. Further embodiments within the scope of the invention will be apparent to the person skilled in the art.

### EXAMPLES

### Example 1

An aqueous liquid composition (Composition 1) having the formula shown in table 1, and being according to the invention was prepared by mixing the ingredients together. Sufficient of the citrate buffer was added to the composition to provide a pH (1 wt % solution in deionised water at 20° C. in the range of from 3 to 4).

TABLE 1
Composition 1

| | % wt |
|---|---|
| Cellulase (as active enzyme) | 0.0135*¹ |
| Pectinase (as active enzyme) | 0.0135*² |
| Lipase (as active enzyme) | 0.0135*³ |
| Citrate buffer (anhydrous | Sufficient to |
| citric acid 55 wt % and NaOH) | provide pH in |
| | range 3-4 |
| Low foaming alkoxylated | 1.0 |
| nonionic surfactant | |
| Water | balance |

*¹Accelerase L or Celluclast NS17034
*²PeKtozyme Powerclear L or Pectin-lyase NS17041
*³Lipex100L or Lipolase 100L

To test the efficacy of Composition 1, 250 ml of the composition was used to treat a soiled dishwashing machine filter which had heavy soiling on its surfaces.

The soiled filters were prepared by adding 50 g of ballast soil is added into the dishwasher before every cycle. After 30 cycles with ballast soil and detergents, the dirty sieve is taken out of the dishwasher and is used fresh for the tests or stored in a freezer. Before using the frozen sieve it has to be put into water for 1 h at RT.

The 6 kg of ballast soil was prepared by mixing the following ingredients;

| Ingredients | Product name (store) | Amount |
|---|---|---|
| Margarine | Rama (Metro) | 600 g |
| tomato ketchup | Heinz-Ketchup (Metro) | 150 g |
| Gravy | Soβe zum Braten-Knorr (Metro) | 150 g |
| egg yolk | large-handelsüblich (Metro) | 18 eggs |
| Mustard | Löwensenf “extrascharf” (Metro) | 150 g |
| potato starch | ref 1.01252.1000 (Merck) | 30 g |
| benzoic acid | reference 1.00136.0250 (Merck) | 6 g |
| milk | 3.5% fat - handelsüblich (Metro) | 300 g |
| water | tap water | 4200 g |

Several dirty filters were produced by carrying out a plurality of dishwashing cycles in the dishwashing machine using a standard soil for cleaning performance (Ballast Soil). A visible, almost continuous, residue/film of wet amorphous matter could clearly be seen on the surface of the filters. Under the microscope it could be seen very clearly that the residue/film is a mixture of organic matter, vegetables fibres, fatty/oily deposits.

Two of these soiled filters were first washed with a premium dishwashing detergent in a normal dishwashing cycle in a dishwashing machine. For both filters there was no visible removal of the soil and they appeared to the naked eye as soiled as they did prior to being washed with the premium dishwashing detergent.

The two filters were then placed in a BOSCH Super Silence SMS69T02EU/07 dishwashing machine and washed under a normal dishwashing cycle (Eco50, 2 hours 20 min). One filter was cleaned using 250 ml of a commercially available dishwashing machine cleaner based on organic acids and surfactants (comparative example) and the other filter was cleaned with 250 ml of Composition 1 according to the invention.

The filter washed with Composition 1 was almost completely clean whereas the filter washed with the commercially available dishwashing machine cleaner still showed a significant amount of the soil.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A machine dishwashing main-wash detergent composition or a dishwashing machine cleaning composition comprising;
(i) at least one cellulase enzyme, and
(ii) at least one pectinase enzyme.

15. A composition according to claim 14, wherein the at least one cellulase enzyme is present in an amount of from 0.005 wt % to 2.5 wt % of active enzyme based on the total weight of the composition

16. A composition according to claim 14 wherein the at least one pectinase enzyme is present in an amount of from 0.005 wt % to 2.5 wt % of active enzyme based on the total weight of the composition.

17. A composition according to claim 14, wherein the composition further comprises at least one enzyme selected from lipases and proteases.

16. A composition according to claim 17, wherein the composition comprises an active amount of the at least one lipase and/or protease in the range of from 0.005 wt % to 2.5 wt % of active enzyme based on the total weight of the composition.

17. A composition according to claim 14, wherein the composition further comprises 0.1 to 10 wt % alkoxylated non-ionic surfactant based on the total weight of the composition.

18. A composition according to claim 14, wherein the composition is a machine cleaner composition and has an acidic pH.

19. A composition according to claim 18, wherein the composition is a machine cleaner composition having a pH of between 3 and 6.

20. A composition according to claim 14, wherein the composition is a machine cleaner composition and further comprises a citrate based buffering system.

21. A composition according to claim 14, wherein the composition is a machine dishwashing main-wash detergent composition and has a pH in the range of from 7 to 11.

22. A method of cleaning the interior of an automatic dishwasher comprising the step of: contacting at least a part of the interior of the dishwasher with a composition according to claim 1, or an aqueous dilution of a composition of claim 1, whilst the automatic dishwasher is undergoing a washing and/or rinsing cycle.

23. A method according to claim 22, wherein the composition is a machine dishwashing main-wash detergent composition.

24. A method according to claim 22, wherein the composition is a machine cleaner composition.

25. The method according to either one of claim 22, wherein the dishwashing machine contains items of kitchenware in its interior during the washing and/or rinsing cycle and composition is a machine dishwashing main-wash detergent composition.

26. The method according to claim 22, wherein the dishwashing machine is empty during the washing and/or rinsing cycle and the composition is a machine cleaning composition.

27. A method of cleaning the interior of an automatic dishwasher, the method comprising contacting at least a part of the interior of the dishwasher with a composition according to claim 1, or an aqueous dilution of a composition of claim 1, whilst the automatic dishwasher is not undergoing a washing or rinsing cycle.

28. A product comprising a container having a dispensing means, wherein the container comprises a composition according to claim 14.

29. A product according to claim 28, wherein the container is at least partly water soluble or water dispersible.

30. A method of degrading fibrous/cellulosic residues in an automatic dishwasher, the method comprising the step of:
contacting at least a part of the interior of the dishwasher with a composition according to claim 1, or an aqueous dilution of a composition of claim 1.
